(19) United States
(12) Patent Application Publication
(10) Pub. No.: US 2004/0156287 A1
(43) Pub. Date: Aug. 12, 2004

(54) Method of accelerating a track-following process for an optical drive

(76) Inventors: Jen-Yu Hsu, Taipei (TW); Hsiang-Yi Fu, Taipei (TW); Tun-Chieh Lee, Taipei (TW); Fu-Hsiang Chen, Taipei (TW); Yao-Chou Tsai, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/638,771

(22) Filed: Aug. 11, 2003

(30) Foreign Application Priority Data
Feb. 10, 2003 (TW) 92102659

(51) Int. Cl. G11B 7/005

(52) U.S. Cl. 369/53.3; 369/59.2; 369/59.19

(57) ABSTRACT

A method of accelerating a track-following process for an optical drive. The optical drive has a motor and a pickup head for reading information from an optical disc therein. According to the method, an input signal with a first frequency and a first phase is received by detecting the rotation speed of the motor and a radius of the information track where the pickup head locates on the optical disc. When either frequency or phase of a data phase locked loop (DPLL) frequency signal of the optical drive is different from the first frequency and the first phase, the DPLL frequency signal is adjusted to the first frequency and the first phase. With the adjusted DPLL frequency signal, data from the optical disc is read correctly.

### BACKGROUND OF THE INVENTION

1. Field of the Invention

The present invention relates to a method of accelerating a track-following process for an optical drive, and particularly to a method of accelerating a track-following process by adjusting a data phase locked loop (DPLL) frequency signal for the optical drive.

2. Description of the Related Art

An optical storage device, i.e. an optical drive, can be either a device or system that is capable of retrieving information stored on an optical disc, or a device or system capable of recording information to and retrieving information from an optical disc. Examples of optical disc storage devices that are capable of retrieving information from an optical disc include compact disc (CD) players, video laser disc (LD) players and compact disc read-only-memory (CD-ROM) drives. Examples of optical disc storage devices that are capable of both recording information to an optical disc and retrieving information from an optical disc include recordable mini-disc (MD) players, magneto-optical (MO) optical drives and compact disc recordable (CD-R) drives.

Generally, information is stored on an optical disc in the form of concentric or spiral tracks referred to as information tracks. In cases where information is already stored on an optical disc, the information tracks contain regions of optical contrast that represent the stored information.

When an optical storage device is in its normal mode of operation, i.e. retrieving information from or recording information to an optical disc, the optical storage device rotates the optical disc while using a light beam emitted from a pickup head to retrieve information from or record information to the optical disc. As the optical disc rotates, the pickup head radially traverses the optical disc along a specific track (an information track in the case of retrieving information from the optical disc, or a track that will become the information track in the case of recording information to the optical disc). This motion of the pickup head is referred to as a track-following motion.

Generally, the reading/retrieving operation in an optical drive can be categorized to two types; that is, the optical disc can be rotated in either a constant rotation speed or a constant linear velocity (CLV). Specifically, when the CLV operation is applied, rotation speed of the optical disc (i.e. the rotation speed of the spindle motor of the optical drive) decreases when the pickup head traverses the optical disc outwardly to keep a constant linear velocity of the information track where the pickup head locates. Thus, a modulation of the rotation speed is required.

In practical application, the concept of data phase locked loop (DPLL) is induced in the CLV operation. The DPLL concept provides a predetermined reference signal, i.e. a DPLL frequency signal, to perform an encoding/decoding process in data reading/retrieving. The use of the DPLL frequency signal for the rotation speed modulation is hereinafter described in detail with reference to FIG. 1.

FIG. 1 illustrates two diagrams showing a DPLL frequency signal and an input signal. The DPLL frequency signal is a fixed sine wave signal. The input signal is also a sine wave signal, which is obtained from a linear velocity of the information track on the optical disc where the pickup head of the optical drive locates. Since the linear velocity of the information track is obtained according to a radius of the information track and the rotation speed of the optical disc, i.e. the rotation speed of the motor of the optical drive, the input signal is determined by the radius of the information track and the rotation speed.

It is obvious that in FIG. 1, frequency and phase of the input signal are different from frequency and phase of the DPLL frequency. Since the DPLL frequency signal is fixed, it is necessary to adjust the input signal, i.e. to perform the rotation speed modulation, to a new input signal shown as the dotted line in FIG. 1 that conforms to the DPLL frequency signal so that the encoding/decoding process in data reading/retrieving performs correctly.

However, when the pickup head traverses the optical disc, a time delay of the rotation speed modulation is required for the motor of the optical drive to reach a stable state of rotation. Accordingly, the time delay slows down the track-following process of the optical drive.

### SUMMARY OF THE INVENTION

Accordingly, an object of the present invention is to provide an accelerated track-following process for an optical drive in which the encoding/decoding process in data reading/retrieving performs correctly and significantly reduces time delay in rotation speed modulation.

The present invention discloses a method of accelerating a track-following process for an optical drive. The optical drive has a motor and a pickup head for reading information from an optical disc therein. According to the method, an input signal with a first frequency and a first phase is received by detecting the rotation speed of the motor and a radius of the information track where the pickup head locates on the optical disc. Further, a predetermined reference signal with a second frequency and a second phase is provided as a data phase locked loop (DPLL) frequency signal of the optical drive. When either the second frequency or the second phase of the DPLL frequency signal of the optical drive is different from the first frequency and the first phase, the DPLL frequency signal is adjusted to the first frequency and the first phase. With the adjusted DPLL frequency signal, data from the optical disc is read correctly.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a DPLL frequency signal and an input signal in the conventional optical drive CLV operation;

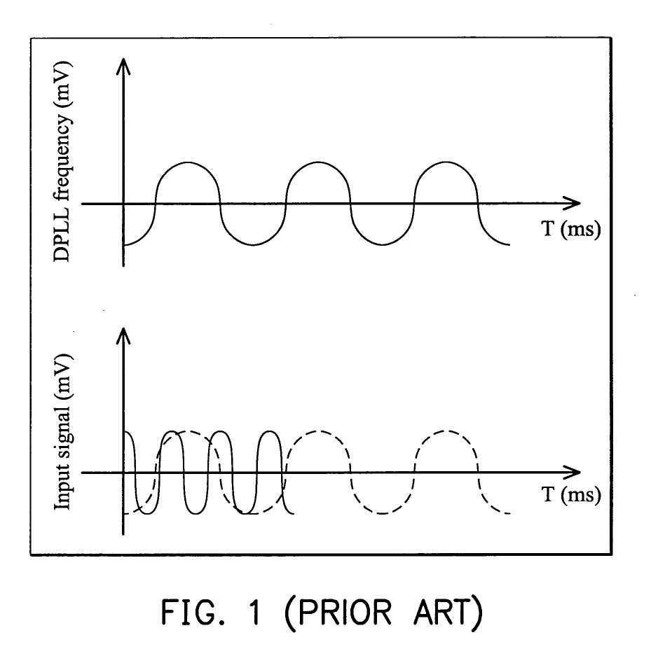

FIG. 2 is a flow chart of the method of accelerating a track-following process for an optical drive of the present invention; and

FIG. 3 illustrates a DPLL frequency signal and an input signal according to the method of the present invention.

### DETAILED DESCRIPTION OF THE INVENTION

Disclosed hereinafter is a method of accelerating a track-following process for an optical drive. A typical optical drive can be used to implement or facilitate description of the method with reference to the figures. Although this method is described in detail, it will be appreciated that this method is provided for purposes of illustration only and that various modifications are feasible without departing from the inventive concept.

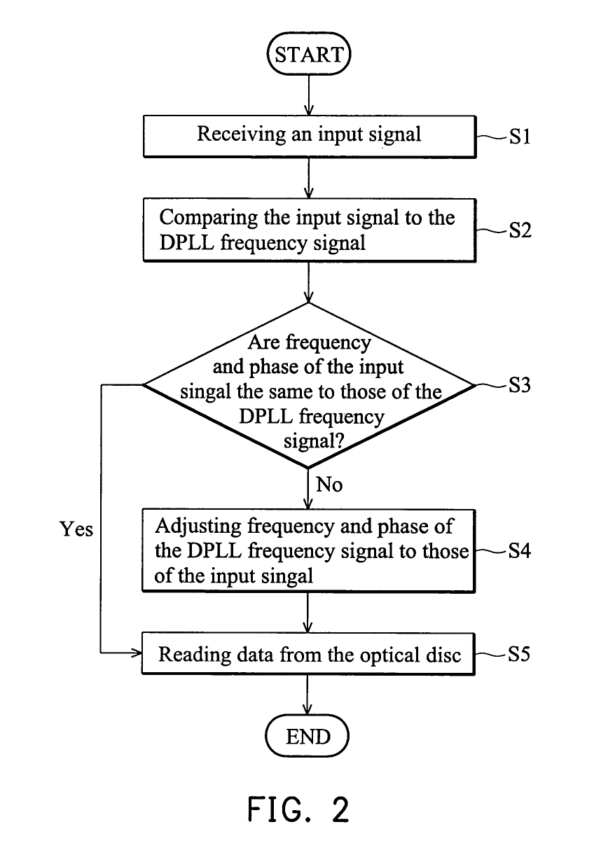

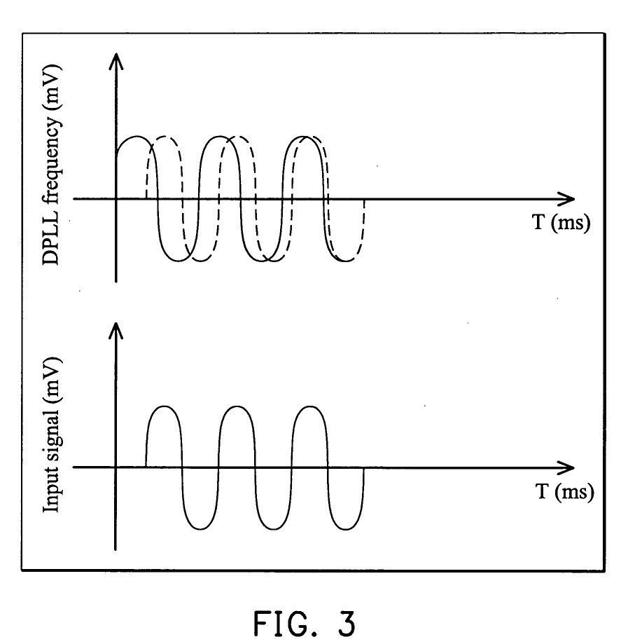

The method of the present invention induces a concept of a variable DPLL frequency signal. An embodiment of the method of the present invention can be hereinafter described with reference to FIG. 2 and FIG. 3.

In the track-following process, once the pickup head of the optical drive moves to a position where the information track is located, the linear velocity of the information track varies. Since the optical drive is in the CLV operation, an input signal shown in FIG. 3 is received (step S1). As mentioned in the prior art, the input signal is a sine wave signal with a first frequency and a first phase, which is transformed from the linear velocity of the information track. Practically, the linear velocity can be obtained by detecting the rotation speed of the motor and a radius of the information track.

Then, the optical drive compares the input signal to the DPLL frequency signal (step S2) for checking whether frequency and phase of the two signals are the same (step S3). The DPLL frequency signal is a predetermined reference signal, which is a sine wave signal a second frequency and a second phase.

It is obvious that the reading process can be performed correctly when the input signal conforms to the DPLL frequency signal (the predetermined reference signal). Accordingly, when the second frequency and the second phase of the DPLL frequency signal (the predetermined reference signal) are the same as the first frequency and the first phase of the input signal, the optical drive reads data from the optical disc directly without performing rotation speed modulation (step S5).

However, when either the second frequency of the DPLL frequency signal (the predetermined reference signal) is different from the first frequency, or the second phase of the DPLL frequency signal (the predetermined reference signal) is different from the first phase, the optical disc does not rotate at the desired rotation speed. At this time, the DPLL frequency signal is adjusted to a new DPLL frequency signal with the first frequency and the first phase (step S4), which is shown as the dotted line in FIG. 3. With the new DPLL frequency signal, the reading process can be performed correctly; accordingly, the optical drive reads data from the optical disc (steps S5).

With the method of the present invention, even if the optical disc does not rotate at the desired rotation speed, the DPLL frequency signal can be adjusted so that the optical drive reads data without performing rotation speed modulation. Thus, the time delay in the rotation speed modulation can be significantly reduced, which accelerates the track-following process.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of accelerating a track-following process for an optical drive, comprising the steps of:
obtaining an input signal with a first frequency and a first phase;
obtaining a predetermined reference signal of the optical drive with a second frequency and a second phase;
adjusting the predetermined reference signal to the first frequency when the first frequency and the second frequency are different;
adjusting the predetermined reference signal to the first phase when a phase difference exists between the first phase and the second phase; and
reading data from an optical disc in the optical drive.

2. The method of accelerating a track-following process for an optical drive as claimed in claim 1, wherein the input signal is a sine wave signal transformed from a linear velocity of an information track on the optical disc where a pickup head of the optical drive locates.

3. The method of accelerating a track-following process for an optical drive as claimed in claim 2, wherein the linear velocity of the information track is obtained according to a rotation speed of a motor of the optical drive and a radius of the information track.

4. A method of accelerating a track-following process for an optical drive, comprising the steps of:
obtaining an input signal with a first frequency and a first phase;
adjusting a data phase locked loop (DPLL) frequency signal of the optical drive to the first frequency and the first phase; and
reading data from an optical disc in the optical drive.

5. The method of accelerating a track-following process for an optical drive as claimed in claim 4, wherein the input signal is a sine wave signal transformed from a linear velocity of an information track on the optical disc where a pickup head of the optical drive locates.

6. The method of accelerating a track-following process for an optical drive as claimed in claim 5, wherein the linear velocity of the information track is obtained according to a rotation speed of a motor of the optical drive and a radius of the information track.

7. A method of accelerating a track-following process for an optical drive, comprising the steps of:
obtaining an input signal with a first frequency and a first phase;
adjusting a data phase locked loop (DPLL) frequency signal of the optical drive to the first frequency and the first phase when either frequency or phase of the DPLL frequency signal is different from the first frequency and the first phase; and
reading data from an optical disc in the optical drive.

8. The method of accelerating a track-following process for an optical drive as claimed in claim 7, wherein the input signal is a sine wave signal transformed from a linear velocity of an information track on the optical disc where a pickup head of the optical drive locates.

9. The method of accelerating a track-following process for an optical drive as claimed in claim 8, wherein the linear velocity of the information track is obtained according to a rotation speed of a motor of the optical drive and a radius of the information track.
